(19) United States
(12) Patent Application Publication
(10) Pub. No.: US 2018/0099752 A1
(43) Pub. Date: Apr. 12, 2018

(54) AIRCRAFT CABIN ARRANGEMENT WITH DEDICATED SEATING CLASSES

(71) Applicant: B/E Aerospace, Inc., Wellington, FL (US)

(72) Inventors: Glenn A. Johnson, Rural Hall, NC (US); Alexander N. Pozzi, Winston-Salem, NC (US); Daniel I. Udriste, Coral Springs, FL (US); Alex Velet, Winston-Salem, NC (US)

(21) Appl. No.: 15/726,594

(22) Filed: Oct. 6, 2017

Related U.S. Application Data
(60) Provisional application No. 62/405,469, filed on Oct. 7, 2016.

(51) Int. Cl. B64D 11/06; B64D 11/00

(52) U.S. Cl. CPC B64D 11/0601; B64D 11/0606; B64D 11/00152; B64D 11/0605; B64D 11/003

(57) ABSTRACT

An aircraft cabin arrangement including a first passenger seating class and a second passenger seating class separated from the first passenger seating class and equipped with at least one amenity dedicated to a need of an infant or a pet. A method of minimizing disruptions between aircraft passengers travelling with children or pets and aircraft passengers travelling without children or pets.

### RELATED APPLICATION AND INCORPORATION BY REFERENCE

This application claims priority from U.S. Application No. 62/405,469 filed Oct. 7, 2016, the entirety of which is incorporated by reference herein.

### BACKGROUND

Aircraft passenger cabins are typically divided into seating classes equipped with amenities commensurate with fares paid. For example, a cabin can be configured with premium and economy seating classes. Premium seating classes can include larger seats, greater seat adjustability, additional leg room, personal video monitors, etc. Economy seating classes can include limited seat adjustability, shared armrests, shared video monitors, etc. Regardless of seating class type, passengers expect a degree of privacy and peace during flight.

Infants and small children can become impatient and bored while travelling, particularly during a long flight. Infants and small children can also have special needs during a flight, for example, nursing, feeding, diaper changes, etc., that require additional space beyond that available in a conventional seating class. Any noise, behavior, and needs that exceed an expected/acceptable level during a flight can be disruptive to other passengers, particularly those in premium seating classes and those travelling without children. Disruptions are undesirable and unwanted by passengers, and can lead to conflict between passengers and added stress in families traveling with infants and small children.

In addition to the needs of families, pets have needs that cannot be addressed in conventional seating classes. For example, airlines require pets to remain in pet carriers during flight, and pet carriers to remain stowed in under-seat stowage space. These requirements not only consume the limited available stowage space for a travelling passenger, but can cause anxiety in pets that can lead to barking, illness and other disruptions. Airlines also limit the number of pets per flight to minimize the impact on passengers sensitive to allergens and overall noise level in the cabin, thus an airline may not be able to accommodate every passenger wanting to travel with a pet.

In view of the above, what is needed is a cabin arrangement equipped to accommodate the needs of all passengers wanting to travel with children and/or pets, in a way that minimizes disruptions between passengers travelling with and without children and/or pets. Such a cabin arrangement would provide a degree of separation and privacy between passengers seated inside and outside of dedicated family and pet seating classes, provide additional room for adults to attend to the needs of infants and children, provide amenities for occupying infants and children during flight, and be configured to cater to the specific needs of families and pet owners, among other features and advantages.

### SUMMARY

In one aspect, embodiments of the inventive concepts disclosed herein are directed to an aircraft cabin arrangement including a first passenger seating class and a second passenger seating class separated from the first passenger seating class and equipped with at least one amenity dedicated to a need of an infant or a pet.

In a further aspect, the cabin arrangement may include a privacy partition separating the first and second passenger seating classes, the privacy partition providing at least one of a visual, an acoustic, and an odor barrier between the first and second passenger seating classes.

In a further aspect, the first passenger seating class may include at least one row of passengers seats arranged facing in a direction of aircraft travel, and the second passenger seating class may include at least one row of passenger seats facing in a direction of an aisle.

In a further aspect, the second passenger seating class may be reserved for passengers traveling with at least one of an infant, a child and a pet.

In a further aspect, the cabin arrangement may include first overhead stowage compartments dedicated for use by passengers seated in the first seating class and second overhead stowage compartments dedicated for use by passengers seated in the second passenger seating class.

In a further aspect, the first passenger seating class may have a first decorative theme, and the second passenger seating class may have a second decorative theme different from the first decorative theme.

In a further aspect, the at least one amenity may be a floor-mounted partition arranged facing a row of seats in the second passenger seating class, and the floor-mounted partition may include at least one of a drawing board, a container holder, and a tray table stowable against the floor-mounted partition and deployable to an over-seat position supported on left- and right-hand armrests of a passenger seat served by the tray table.

In a further aspect, the at least one amenity may be a tray table topped with a sheet comprising features for engaging interlocking plastic bricks.

In a further aspect, the at least one amenity may be a seatback tablet holder made from a resiliently deformable material shaped to retain corners of a tablet engaged in the seatback tablet holder, and wherein the seatback tablet holder may be supported on a ledge of a seatback pocket.

In a further aspect, the at least one amenity may be a lap holder including an upper portion including a cushioned tray and a lower portion including leg recesses and seat belt receiving openings.

In a further aspect, the second passenger seating class may include a passenger seat including a seat bottom configured to pivot forward to expose underlying seat beams, wherein the at least one amenity is a collapsible pet carrier having bottom features configured to engage the exposed seat beams such that when the collapsible pet carrier is installed on the exposed seat beams the collapsible pet carrier is constrained between an underside of the seat bottom and a forward face of a seatback of the passenger seat.

In a further aspect, the second passenger seating class may include dedicated open floor space for a child or pet to play.

In a further aspect, the at least one amenity may be a lower tray spaced below and supported by an upper seatback tray table, wherein dedicated space is provided between the upper and lower trays for stowing a pet carrier elevated off a floor, the pet carrier provided by an airline for use during a flight.

In another aspect, embodiments of the inventive concepts disclosed herein are directed to an aircraft cabin arrangement including a first passenger seating class and a second passenger seating class dedicated for use by passengers travelling with children or pets, the second passenger seating class separated from the first passenger seating class and equipped with at least one amenity found only in the second passenger seating class and dedicated to serve a need of a child or a pet.

In a further aspect, the cabin arrangement may include a privacy partition for at least one of visually, acoustically and olfactorily isolating the first and second passenger seating classes.

In a further aspect, the first passenger seating class may have a first decorative theme and the second passenger seating class may have a second decorative theme different from the first decorative theme.

In another aspect, embodiments of the inventive concepts disclosed herein are directed to a method of minimizing disruptions between aircraft passengers travelling with children or pets and aircraft passengers travelling without children or pets, the method including positioning a first passenger seating class in a first region of an aircraft interior and positioning a second passenger seating class in a second region of the aircraft interior separated from the first region, the second passenger seating class dedicated for use by passengers travelling with children or pets and equipped with at least one amenity found only in the second passenger seating class and dedicated to serve a need of a child or a pet.

Embodiments of the invention can include one or more or any combination of the above aspects, features and configurations.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a perspective view of a family seating class in an aircraft cabin arrangement;

FIG. 2 is an overhead perspective view of the family seating class of FIG. 1;

FIG. 3 details deployable tables in the family seating class;

FIG. 4 details seatback tablet holders in the family seating class;

FIGS. 5A-C illustrate an infant or pet lap holder and use thereof during flight;

FIGS. 6A-B illustrate a collapsible pet holder and corresponding seat;

FIGS. 7A-B illustrate an aircraft cabin arrangement including dedicated pet and family passenger compartments; and

FIGS. 8A-C illustrate gate and aircraft pet containment solutions and tracking.

### DETAILED DESCRIPTION OF EXEMPLARY EMBODIMENTS

The inventive concepts are described hereinafter with reference to the accompanying drawings in which exemplary embodiments are shown. However, the inventive concepts may be embodied in many different forms and should not be construed as limited to the representative embodiments set forth herein.

The inventive concepts disclosed herein are generally directed to cabin arrangements including dedicated passenger seating classes equipped with amenities that cater to the specific needs of a family travelling with infants and children or passengers travelling with pets or service animals. In one aspect, separation is provided between the dedicated passenger seating classes and other seating classes not dedicated for any particular passenger type, for example, general seating classes, premium seating classes, economy seating classes, etc. Separation may take the form of physical separation in terms of physical location within the cabin, physical separation achieved with fixed or movable partitions, acoustic separation using sound deadening materials or electronic noise cancelling equipment, etc., visual separation, odor barriers, etc. Separation between dedicated and non-dedicated passenger seating classes may include one or more or any combination of the above manners of separation, with an exemplary goal being to prevent disruptions between passenger in different seating classes.

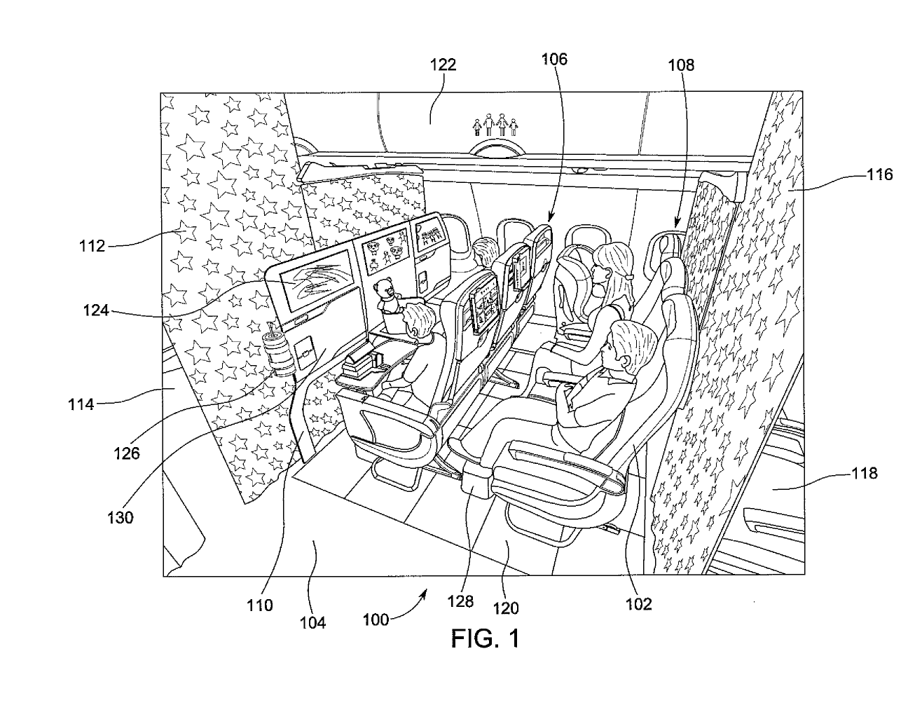

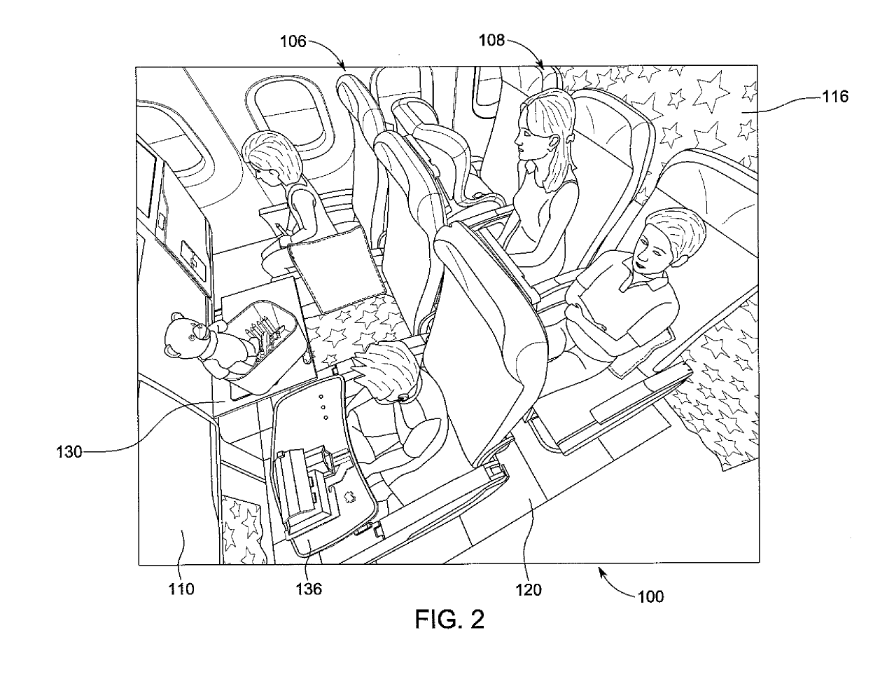

In an exemplary embodiment, FIGS. 1 and 2 illustrate a dedicated passenger seating class 100 dedicated for use by a passenger travelling with an infant or child, for example, a family travelling with at least one child, a single parent travelling with at least one child, children travelling with other children or alone, etc. The passenger seating class 100, also referred to herein as a “family seating class”, may be occupied by passengers that are related or unrelated. For example, the entire family seating class can be further divided into smaller sections each reserved for a single family travelling together. Multiple family seating classes can also be strategically positioned within the interior of the aircraft.

The passenger seating class 100 as shown includes two rows three laterally-adjacent passenger seats 102 arranged laterally adjacent a longitudinal aisle 104 and facing a direction of aircraft travel. The forward row of seats 106 is longitudinally aligned with the aft row of seats 108 such that the seatbacks of the forward row of seats 106 can serve as mounting locations for tray tables, tablet holders, video monitors, storage pockets, etc. serving passenger seated in the aft row of seats 108.

A fixed, floor-mounted partition 110 is positioned directly forward of the forward row of seats 106 and can be equipped with at least one amenity serving the needs of an infant or child, as discussed in detail below. A forward or first privacy partition 112 is positioned immediately forward of the floor-mounted partition 110 and serves to separate the dedicated passenger seating class 100 from a non-dedicated seating class 114 immediately forward of the first privacy partition 112. A rear or second privacy partition 116 positioned immediately aft of the aft row of seats 108 separates the dedicated passenger seating class 100 from another non-dedicated passenger seating class 118 that may be the same or different from the forward non-dedicated passenger seating class 114. Alternatively, the forward and rear privacy partitions 112, 116 can be used to separate the dedicated passenger seating class 100 from other like dedicated passenger seating classes 100, lavatories, galleys, service areas, cockpit, etc.

The forward and rear privacy partitions 112, 116 can be fixed or moveable or a combination thereof. As shown, the forward and rear privacy partitions 112, 116 extend from floor-to-ceiling adjacent the aisle 104 and from floor-to-stowage compartment adjacent the fuselage so as to substantially form a continuous barrier. Each of the forward and rear privacy partitions 112, 116 can be made from any material including, but not limited to, transparent materials, translucent materials, opaque materials, rigid materials, flexible materials, fabrics, etc., all which may or may not include sound-deadening coatings, fillers or additives, odor blocking coatings, fillers or additives, and like materials.

The dedicated passenger seating class 100 can have a first decorative theme the same as or different from a second decorative theme of the other non-dedicated passenger seating classes in the cabin. In the exemplary embodiment shown, the decorative theme of the dedicated passenger seating class 100 is colorful and includes multi-colored privacy partitions 112, 116 having a child-friendly pattern, multicolored floor-mounted partition 110, and multi-colored tile flooring 120. The floor-mounted partition 110 can be made from high impact plastic for durability and cleanability. The flooring 120 can include rubber tiles or carpet squares for cleanability and ease of replacement. Suitable flooring materials include, but are not limited to, FAA-approved, slip-resistant, fire-resistant materials such as vinyl, rubber and like materials. The flooring can be textured for slip-resistance, and can be in the form of a sheet supplied in rolls. The theme of the non-dedicated passenger seating classes can include more subdued color schemes as typical of conventional seating classes.

The dedicated passenger seating class 100 can include overhead stowage compartments or bins 122 indicated for use only by passengers seated in the dedicated passenger seating class 100, The non-dedicated passenger seating classes can be equipped with overhead stowage compartments indicated for use only by passengers seated in the non-dedicated seating areas. Overhead stowage compartments in the dedicated passenger seating class 100 can be sized and shaped to accommodate specific items including, but not limited to, strollers, car seats, pack-and-plays, pet carriers, etc.

The floor-mounted partition 110 can serve as the mounting location for drawing boards 124 for use by passengers directly facing the partition 110. Suitable examples of drawing boards include, but are not limited to, dry erase boards and chalk boards for reusability and cleanability. A container holder 126 can be located to one side of the floor-mounted partition 110 configured to hold beverage containers, bottles, sippy cups, wipes, etc. for use by passengers seated in the dedicated passenger seating class 100 as well as the flight crew.

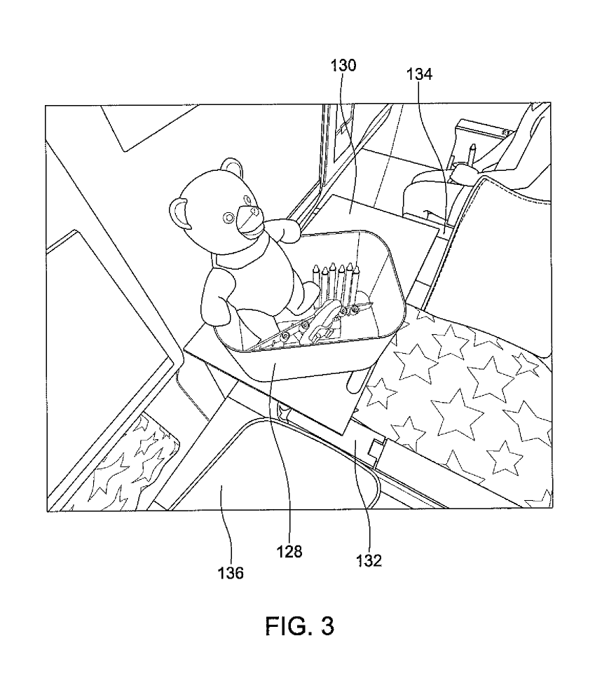

A foot stool 128 can serve in one orientation to support a child's feet, as best shown in FIG. 1, while in a second orientation can be used to store toys, drawing implements, interlocking plastic bricks, etc., as best shown in FIG. 3. The foot rests 128 can be removable and stackable, and can secure around/to track fasteners, luggage retaining bars, or other floor or seat structure to secure the foot rest in place. A table 130, mounted to the floor-mounted partition 110, is configured to pivot between a stowed position flush against the front face of the floor-mounted partition 110 and a deployed overseat position wherein the table 130 directly engages, spans, and is supported by the left-hand and right-hand armrests (132, 134) of the passenger seat served by the table 130.

As best shown in FIG. 2, a tray table 136 deployable from within one of the seat armrests (132, 134) can be topped with a sheet 138 including features for engaging interlocking plastic bricks, for example, Lego®, Duplo® or Mega Blocks® compatible. The building blocks themselves can be stored in a foot stool 128.

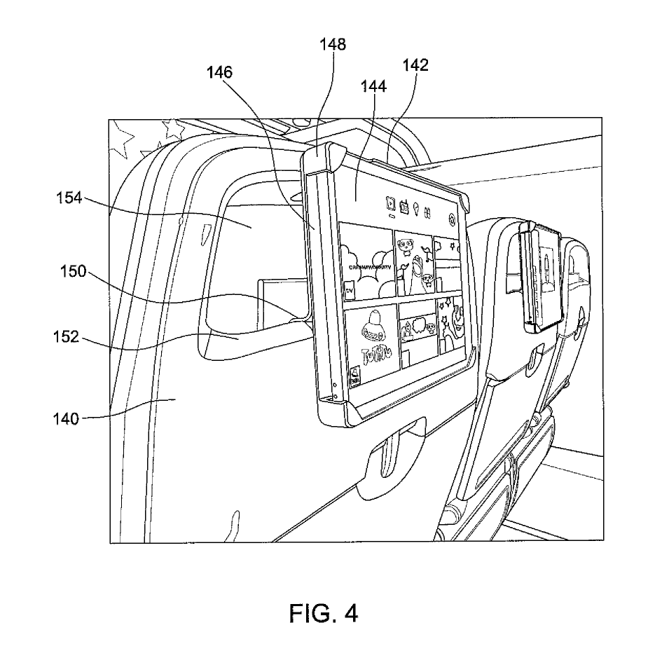

As shown in FIG. 4, each passenger seatback 140 can be equipped with a tablet holder 142 configured to engage each of the four corners of the tablet 144 held therein. In the exemplary embodiment shown, the tablet holder 142 includes a planar base 146, corner retainers 148 made from a resiliently deformable material, and a flange 150 perpendicular to the base 146 arranged to seat and be supported upon a ledge 152 of a seatback pocket 154. Tablets may be provided by the airline or can be carried aboard by passengers. Various sized tablet holders can be removably installed depending on the tablet size.

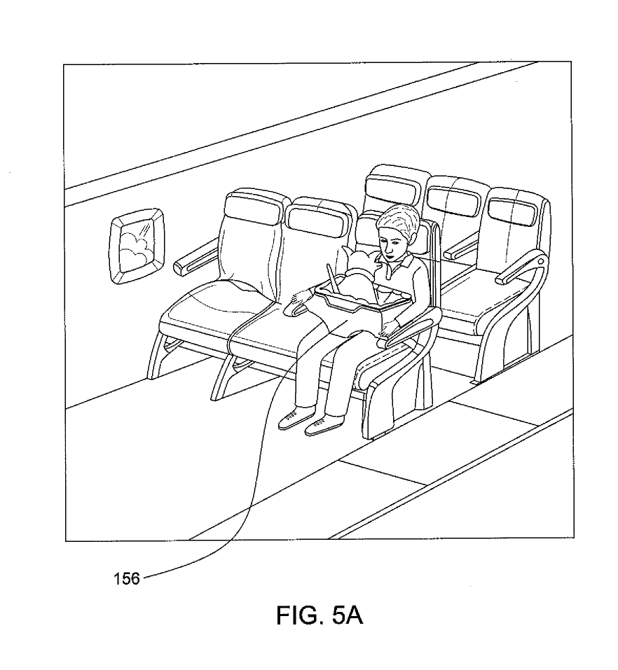

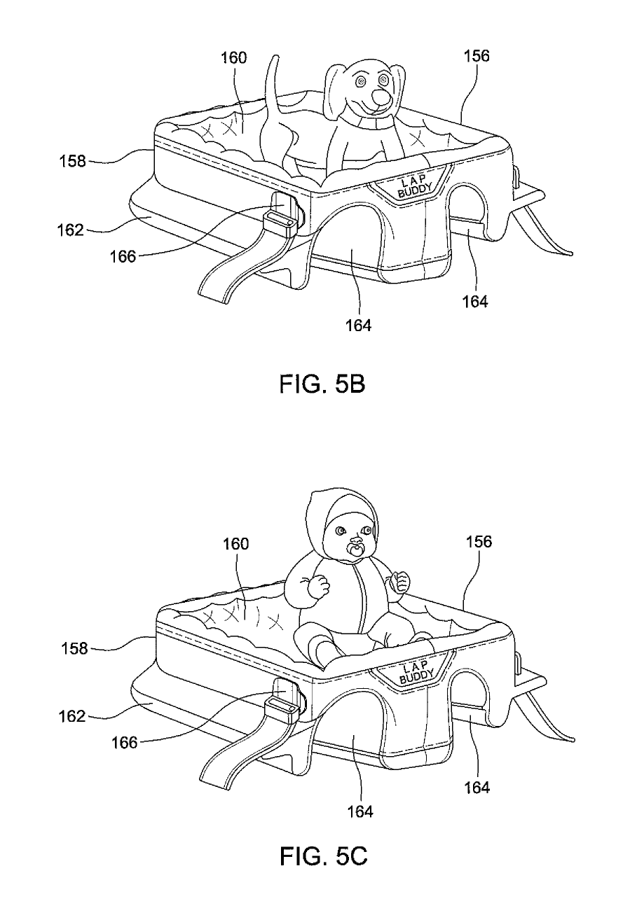

FIGS. 5A-C illustrate a lap holder 156 amenity for use during flight. The lap holder 156 generally includes an upper portion 158 including a cushioned tray 160 and a lower portion 162 including leg recesses 164 and seat belt receiving openings 166. The lap holder 156 can be used to hold an infant or pet during flight. As used herein, the term “pet” includes all animals including service animals. In use, the lap holder 156 is positioned over the user's legs, the existing seat belt engaged in the lap holder 156, and the child or pet held comfortably in the cushioned tray 160. The entire assembly 156 can be cushioned for comfort and safety.

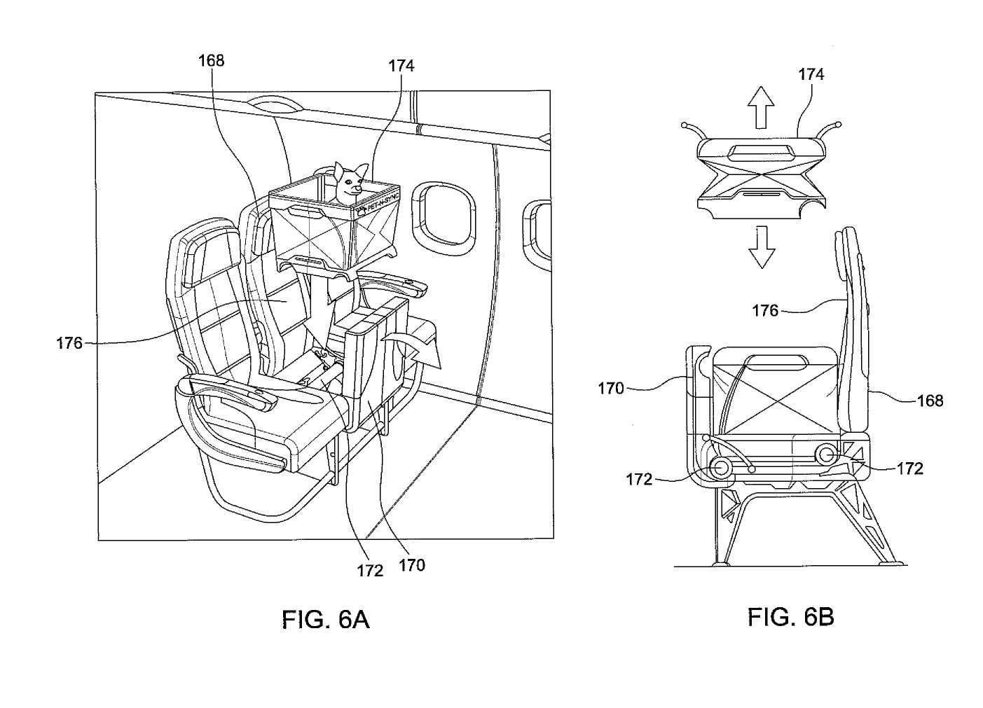

FIGS. 6A-B illustrate another exemplary embodiment of a pet carrier. In this embodiment, a particular passenger seat 168 positioned in the dedicated passenger seating class includes a seat bottom 170 configured to pivot forward to expose underlying seat beams 172. The amenity is a collapsible pet carrier 174 having bottom features configured to engage the exposed seat beams 172 such that when the collapsible pet carrier 174 is installed on the exposed seat beams 172 the collapsible pet carrier 174 is maintained between an underside of the seat bottom 170 and a forward face of a seatback 176 of the passenger seat 168.

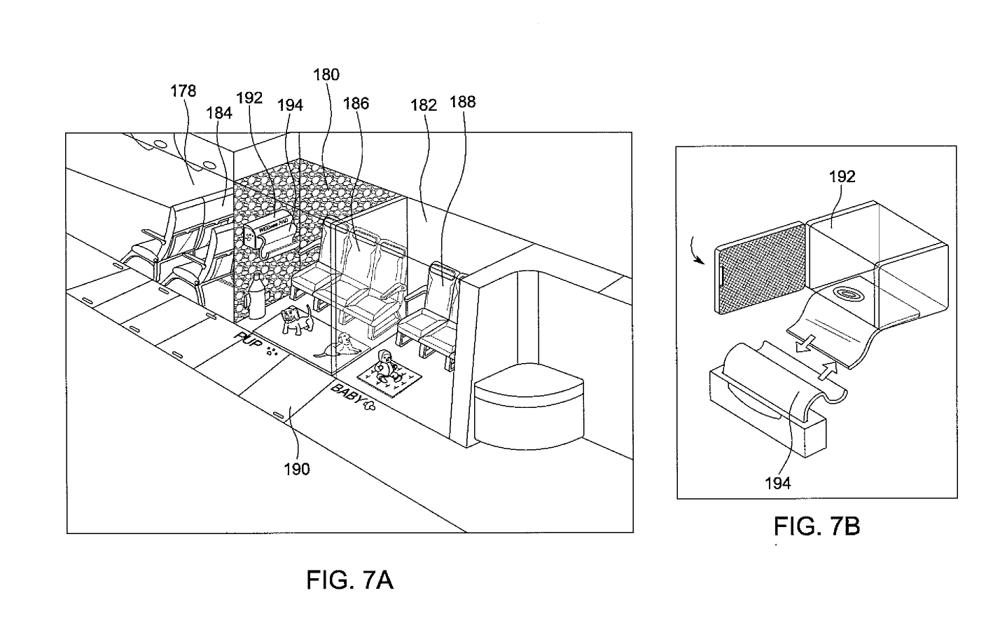

FIGS. 7A-B illustrate an exemplary cabin arrangement including a non-dedicated passenger seating class 178, a first dedicated passenger seating class 180 dedicated for passengers travelling with pets, and a second dedicated passenger seating class 182 dedicated for passengers travelling with a child. While the passenger seats 184 in the non-dedicated passenger seating class 178 are forward facing (i.e. face the direction of aircraft travel), the passenger seats 186, 188 in the first and second dedicated passenger seating classes 180, 182 face the longitudinal aisle 190. The seating classes 178, 180, 182 can be separated with partitions, and in a particular embodiment, can be closed off with a door. A dispenser 192 configured to dispense disposable mats 194 can be installed within at least one of the first and second dedicated passenger seating classes 180, 182.

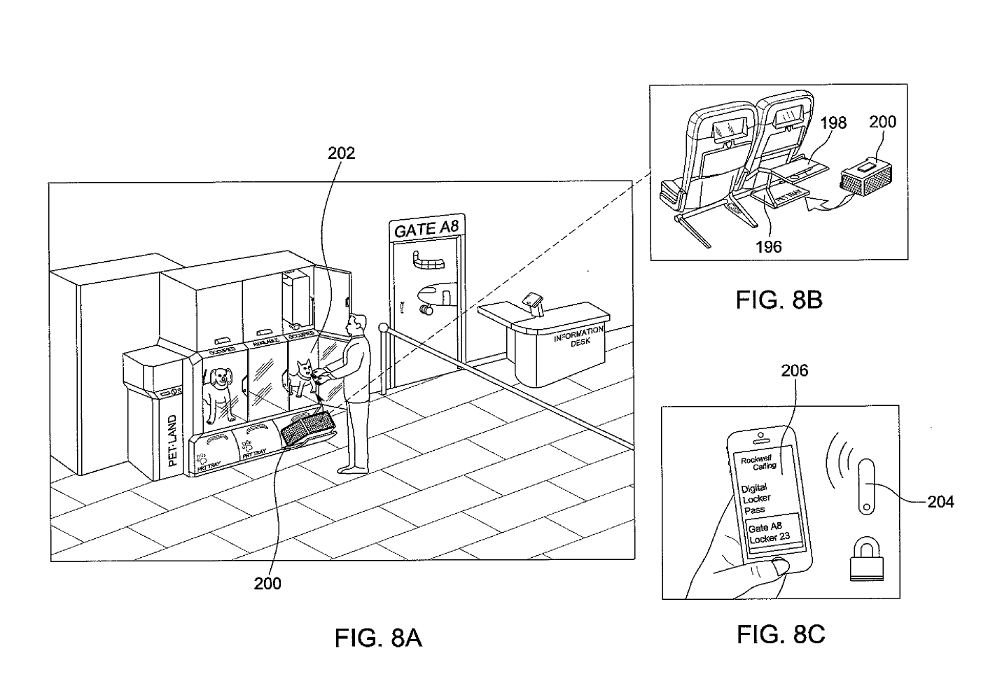

FIGS. 8A-C illustrate a pet containment solution generally including an amenity in the form of a lower tray 196 spaced below and supported by an upper seatback tray table 198, wherein dedicated space is provided between the upper and lower trays 198, 196 for stowing a pet carrier 200 elevated off the floor. The pet carrier 200 can be supplied by the airline for use during a flight. Pet carriers 200 can be supplied in storage lockers 202 located at the gate or elsewhere in the terminal. Such a solution allows a passenger to arrive at the airport without a carrier, obtain a carrier from the carrier kiosk, and stow the pet in the carrier 200 in the space provided without sacrificing convention seat stowage locations. The pet carrier 200 can be equipped with a tracking sensor 204 locatable with a downloadable tracking application 206. Pets can also be temporarily stored in the lockers 202 and the application function to indicate the locked/unlocked status of the locker 202.

Passenger seats in the dedicated passenger seating classes can also be equipped with latches, locks, etc. for securing a child safety seat supplied by the airline or carried aboard. For example, the passenger seats can be equipped with Isofix™ latches, which are the international standard for attachment points for child safety seats in passenger vehicles. Other forms of latches can include lower anchors and tethers.

In a further exemplary embodiment, the inventive concepts disclosed herein are directed to a method of minimizing disruptions between aircraft passengers travelling with children or pets and aircraft passengers travelling without children or pets, the method including positioning a first passenger seating class in a first region of an aircraft interior, and positioning a second passenger seating class in a second region of the aircraft interior separated from the first region, the second passenger seating class dedicated for use by passengers travelling with children or pets and equipped with at least one amenity found only in the second passenger seating class and dedicated to serve a need of a child or a pet.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. An aircraft cabin arrangement, comprising:
a first passenger seating class; and
a second passenger seating class separated from the first passenger seating class and equipped with at least one amenity dedicated to a need of an infant or a pet.

2. The aircraft cabin arrangement of claim 1, further comprising a privacy partition separating the first and second passenger seating classes, the privacy partition providing at least one of a visual, an acoustic, and an odor barrier between the first and second passenger seating classes.

3. The aircraft cabin arrangement of claim 1, wherein the first passenger seating class includes at least one row of passengers seats arranged facing in a direction of aircraft travel, and the second passenger seating class includes at least one row of passenger seats facing in a direction of an aisle.

4. The aircraft cabin arrangement of claim 1, wherein the second passenger seating class is reserved for passengers traveling with at least one of an infant, a child and a pet.

5. The aircraft cabin arrangement of claim 1, further comprising first overhead stowage compartments dedicated for use by passengers seated in the first seating class, and second overhead stowage compartments dedicated for use by passengers seated in the second passenger seating class.

6. The aircraft cabin arrangement of claim 1, wherein the first passenger seating class has a first decorative theme, and the second passenger seating class has a second decorative theme different from the first decorative theme.

7. The aircraft cabin arrangement of claim 1, wherein the at least one amenity is a floor-mounted partition arranged facing a row of seats in the second passenger seating class, the floor-mounted partition comprising at least one of a drawing board, a container holder, and a tray table, the tray table stowable against the floor-mounted partition and deployable to an over-seat position supported on left- and right-hand armrests of a passenger seat served by the tray table.

8. The aircraft cabin arrangement of claim 1, wherein the at least one amenity is a tray table topped with a sheet comprising features for engaging interlocking plastic bricks.

9. The aircraft cabin arrangement of claim 1, wherein the at least one amenity is a seatback tablet holder made from a resiliently deformable material shaped to retain corners of a tablet engaged in the seatback tablet holder, and wherein the seatback tablet holder is supported on a ledge of a seatback pocket.

10. The aircraft cabin arrangement of claim 1, wherein the at least one amenity is a lap holder comprising:
an upper portion comprising a cushioned tray; and
a lower portion comprising leg recesses and seat belt receiving openings.

11. The aircraft cabin arrangement of claim 1, further comprising a passenger seat positioned in the second passenger seating class comprising a seat bottom configured to pivot forward to expose underlying seat beams, and wherein the at least one amenity is a collapsible pet carrier comprising bottom features configured to engage the exposed seat beams such that when the collapsible pet carrier is installed on the exposed seat beams the collapsible pet carrier is maintained between an underside of the seat bottom and a forward face of a seatback of the passenger seat.

12. The aircraft cabin arrangement of claim 1, wherein the second passenger seating class comprises dedicated open floor space for a child or pet to play.

13. The aircraft cabin arrangement of claim 1, wherein the at least one amenity is a lower tray spaced below and supported by an upper seatback tray table, wherein dedicated space is provided between the upper and lower trays for stowing a pet carrier elevated off a floor, the pet carrier provided by an airline for use during a flight.

14. An aircraft cabin arrangement, comprising:
a first passenger seating class; and
a second passenger seating class dedicated for use by passengers travelling with children or pets, the second passenger seating class separated from the first passenger seating class and equipped with at least one amenity found only in the second passenger seating class and dedicated to serve a need of a child or a pet.

15. The aircraft cabin arrangement of claim 14, further comprising a privacy partition for at least one of visually, acoustically and olfactorily isolating the second passenger seating class.

16. The aircraft cabin arrangement of claim 14, wherein the first passenger seating class has a first decorative theme and the second passenger seating class has a second decorative theme different from the first decorative theme.

17. The aircraft cabin arrangement of claim 14, wherein the at least one amenity is at least one of a tray table topped with a sheet comprising features for engaging interlocking plastic bricks, a dedicated pet carrier, and a lower tray spaced below and supported by an upper seatback tray table providing dedicated space between the upper and lower trays for stowing the dedicated pet carrier elevated off a floor.

18. A method of minimizing disruptions between aircraft passengers travelling with children or pets and aircraft passengers travelling without children or pets, the method comprising:
positioning a first passenger seating class in a first region of an aircraft interior; and
positioning a second passenger seating class in a second region of the aircraft interior separated from the first region, the second passenger seating class dedicated for use by passengers travelling with children or pets and equipped with at least one amenity found only in the second passenger seating class and dedicated to serve a need of a child or a pet.

19. The method of claim 18, further comprising providing a privacy partition to separate the first and second passenger seating classes, the privacy partition providing at least one of a visual, an acoustic, and an odor barrier between the first and second passenger seating classes.

20. The method of claim 18, wherein the first passenger seating class has a first decorative theme and the second passenger seating class has a second decorative theme different from the first decorative theme.
